(19) United States
(12) Patent Application Publication
(10) Pub. No.: US 2025/0376005 A1
(43) Pub. Date: Dec. 11, 2025

(54) AIR HEATER FOR MOBILE APPLICATIONS WITH REDUCED HOUSING SURFACE TEMPERATURE

(71) Applicant: Webasto SE, Stockdorf (DE)

(72) Inventors: Vitali Dell, Stockdorf (DE); Christoph Hampel, Stockdorf (DE); Marco Braun, Stockdorf (DE); Tobias Blädel, Stockdorf (DE)

(21) Appl. No.: 19/223,982

(22) Filed: May 30, 2025

(30) Foreign Application Priority Data
Jun. 5, 2024 (DE) 102024205192.6

(51) Int. Cl. B60H 1/22; F24H 3/06; F24H 9/1836

(52) U.S. Cl. CPC B60H 1/2212; F24H 3/065; F24H 9/1836

(57) ABSTRACT

An air heater for a vehicle comprises a subassembly for generating heat, a heat exchanger which thermally interacts with the subassembly, an outer housing which receives the subassembly and the heat exchanger, wherein the outer housing and the heat exchanger together form at least one heating air channel which is formed by an inner wall of the housing and an outer wall of the heat exchanger, and a heating air blower which is configured to draw in heating air via a suction opening of the outer housing and to convey it in a flow direction through the at least one heating air channel and to discharge the heating air via a discharge opening.

### CROSS-REFERENCE TO RELATED APPLICATION

This application claims priority to German Application No. DE 102024205192.6 filed on Jun. 5, 2024, which is incorporated herein by reference in its entirety for all purposes.

### TECHNICAL FIELD

The present invention relates to an air heater for mobile applications with a reduced housing surface temperature.

### BACKGROUND

Air heaters for mobile applications, in particular in vehicles or construction machines, are conventionally operated on the basis of combustible. In a combustion chamber, heat is released by means of a combustible supplied from a tank. The hot combustion gases discharge in a heat exchanger some of the usable thermal energy to a heating air which is conveyed via a heating air blower. In this instance, the air to be heated (in the present document also already referred to as heating air) is guided by generally upstream heating air blowers by means of a housing shell, which generally has one wall, of an outer housing via the heat exchanger. Such housing shells are particularly used for selective air guidance.

An outer housing may comprise one or more housing shells which are usually formed from plastics material. The outer housing or the corresponding housing shell is installed on the air heater in such a manner that there is a slight spacing from the external ribs which extend outwards from a base member of the heat exchanger so that one or more heating air channels, through which the heating air blower can convey the heating air, are formed in the gap. Nevertheless, the outer housing or the corresponding housing shells substantially reproduce an external contour of the entire air heater.

The ribs of the heat exchanger increase in the relevant heating air channel the contact surface between the heat exchanger and the heating air and guide the heating air in individual flow channels between the ribs. In this manner, an efficient transfer of the heat between the heat exchanger and the heating air is obtained. The heating air becomes heated along the flow path formed thereby and is finally transferred to a downstream application, for example, a hose system having one or more outflow openings in the passenger compartment of the vehicle.

In the event of one-walled outer housings or corresponding housing shells, however, an undesirable effect can also occur in that, by the heated heating air being guided along the inner surface of the housing shell(s), heat is convectively transmitted to the housing shell(s) in an increased manner. Furthermore, heat can also be transported via radiation over the gap from an outer surface of the heat exchanger, that is to say both of the base member and of the ribs, to the housing shell(s). The one-walled housing shell(s) can consequently reach substantially increased temperatures, which may be more than 50° C., locally on a touchable outer side of the air heater.

Consequently, there may occur injuries or burns upon contact. In order to avoid this, permitted surface temperatures which are binding for manufactures have been set out for heating systems of vehicles by the European Economic Commission (ECE) in the Regulation ECE R-122. Therefore, the manufacturers have to configure their air heaters in an accordingly compliant manner.

For newer air heating systems, however, the demand for higher power densities or, in other words, for increasing compactness is increasing. However, this involves a simultaneous requirement for greater spread of the heating power, particularly for a higher maximum heating power. This requirement can be met only by using a very efficient and compact heat exchanger. Accordingly, the housing shells or the outer housing are then also very compact, as described.

In this case, as a result, more heat has to be transmitted to the shells per surface unit for the same arrangement as in the prior art, which is almost impossible to prevent. This necessarily leads to an increase in the surface temperatures in comparison with conventional air heaters.

In this case, particularly in regions of the respective heating air channel in which the heating air is redirected, a high heat transmission coefficient can occur at the inner housing side and accordingly an increased thermal input into the outer housing or the relevant housing shell. For one-walled housing shells in an arrangement according to the prior art, consequently, for example, the permitted surface temperatures, which are set out in the Regulation ECE R-122 (Appendix 5, Point 2) of 80° C. during stationary heating operation or 110° C. during overheating for specific operating conditions may possibly be exceeded

### SUMMARY

Therefore, an object of the present invention is to provide an air heater in which even with a compact construction and higher volumetric power density the temperatures which occur on an outer surface of an outer housing, in particular locally occurring maximum temperatures, are kept within a range which does not endanger persons and/or the limit values which are determined, for example, in accordance with the Regulation ECE R-122 (or in accordance with the similar provisions which apply in third states or regions) for the surface temperature are complied with.

According to different aspects of the invention, in this regard an air heater for mobile applications, for example, for a vehicle, is proposed, wherein in particular a fuel-operated air heater is involved. However, according to these aspects, it is also not excluded that the heat generation is supplied from an electrical energy source. The term “vehicles” is intended to be understood to mean passenger vehicles, utility vehicles, mobile homes, trailers for lorries or utility vehicles, or mobile homes, construction machines or motor-operated or sail-operated ships or houseboats, etc., and the aspects are not limited to specific applications.

The air heater has a subassembly for generating heat and a heat exchanger which thermally interacts with the subassembly. The heat exchanger is configured here to receive thermal energy generated by the subassembly and to transmit it to a medium, in particular to heating air. To this end, the air heater further has an outer housing which receives the subassembly and the heat exchanger. The outer housing and the heat exchanger together form in this case at least one heating air channel which is formed by an inner wall of the outer housing and an outer wall of the heat exchanger. In this heating air channel, the heating air can be guided via or past the heat exchanger in order to take up heat from it. In order to form the heating air channel, the outer housing can be spaced apart from the heat exchanger. The outer housing consequently delimits the heating air channel in an outward direction.

The outer housing can have a construction with one or more shells. That is to say that two or more housing shells which form an inner space—in a state complementing each other—in which (inter alia) the subassembly for generating heat and the heat exchanger are received may also absolutely be present. In the case of a multi-shell construction, it may be the case, and also preferable, that only one of the housing shells with the inner wall thereof which constitutes only a portion of the inner wall of the outer housing is opposite the outer wall or outer surface of the heat exchanger and thereby forms the heating air channel.

Preferably, the outer housing or at least the housing shell opposite the heat exchanger is configured with one wall. This does not exclude a multi-layered construction of this one wall. The presence of individual empty spaces as a result of the construction within the outer wall is not detrimental.

The air heater further has a heating air blower which is configured to draw in heating air via a suction opening of the outer housing and to convey it in a flow direction through the at least one heating air channel and to discharge the heating air via a discharge opening of the outer housing. In a preferred embodiment, the heating air blower is arranged upstream of the heating air channel (counter to the flow direction). This can reduce the thermal stress on the drive or motor of the heating air blower and also a corresponding impeller and the bearing thereof.

A characterizing feature for the aspects set out here is a separation element which is arranged in the at least one heating air channel and which is formed between the outer face of the heat exchanger and the housing. The separation element extends in a portion of the heating air channel in the flow direction determined by the operation of the heating air blower. The portion can conceivably also take up the entire length of the heating air channel in the flow direction. However, only a partial portion of the heating air channel is preferable. That is to say, in the latter case, that-when viewed in the longitudinal direction—the separation element is arranged in the mentioned portion of the heating air channel, but in another portion it is not. When viewed in the circumferential direction, however, the separation element preferably surrounds the heat exchanger completely.

It should be noted that the heating air channel is defined here by a gap or intermediate space between the outer housing (or housing shell) and the heat exchanger. A channel which bridges a distance between the heating air blower which can be arranged, for example, near the suction opening at a front end in the air heater and the heat exchanger can be arranged directly upstream of this heating air channel in the air heater. This channel and the heating air channel can merge directly into each other.

The separation element now subdivides in this portion the heating air channel into an inner heating air channel portion which is determined between the separation element and the outer wall of the heat exchanger and an outer heating air channel portion which is determined between the separation element and the inner wall of the housing. As a result of this subdivision, the heating air which flows in the heating air channel during operation is divided at an inflow region into the two heating air channel portions into correspondingly two parallel part-flows. However, these two heating air channel portions still together conceptually form the heating air channel.

The separation element is preferably in the form of a thin wall (in order not to block the heating air channel which would result in an increased air resistance and would therefore require a higher blower power) which extends between the two heating air channel portions and which separates them from each other. In the inner heating air channel portion, the heating air continues to be in contact with the outer wall or outer surface of the heat exchanger and is heated further with a progressively travelled distance. However, the part-flow which is conveyed in the outer heating air channel portion is heated only in a limited manner, that is to say no longer by direct convective heat transmission as a result of contact with the heat exchanger, but instead substantially only still via contact with the separation element. As a result of this, in the portion in which the separation element is provided a comparatively smaller quantity of heat is transmitted to the inner wall of the outer housing (or the corresponding housing shell), with the result that the temperature which is reached at the outer surface of the outer housing is also reduced in comparison with a (conventional) case, in which no separation element is provided.

However, aspects and exemplary embodiments of the invention nevertheless make provision for the heating air which is ultimately discharged for subsequent applications (for example, passenger compartment heating, etc.) to include both portions, that is to say not only the heating air which is further powerfully heated in the inner heating air channel portion but also the heating air which is heated moderately in the outer heating air channel portion. Some exemplary embodiments which are described below therefore make provision for the two part-flows to be guided back together still in the air heater before being discharged via the discharge opening so that the received quantity of heat of the outer part-flow is also used and the heating power is configured efficiently overall.

Preferably, both the inner heating air channel portion and the outer heating air channel portion are together connected to a non-subdivided heating air channel portion of the heating air channel which extends continuously and without barriers (without any separation element) from the inner wall of the outer housing as far as the outer wall of the heat exchanger at the side thereof which determines the inflow region for heating air counter to the flow direction of the heating air. Within this non-subdivided heating air channel portion of the heating air channel, consequently, the conveyed heating air can become heated during operation up to a point at which the thermal discharge of the heating air to the outer housing exceeds a critical limit which would, without additional measures, result in a surface temperature being reached at a location downstream in the flow direction on the outer housing, which surface temperature would, for example, no longer be compatible with the Regulation ECE R-12 mentioned in the introduction (Appendix 5, Point 2). As a result of the separation of the heating air flow into part-flows using the separation element, however, the further increase of the surface temperature is kept within limits.

The inflow region can be formed by an inlet edge of the separation element. The positioning of the inlet edge or the inflow region along a longitudinal axis of the heat exchanger parallel with the flow direction can be configured in the event of the upstream, non-subdivided heating air channel portion so that the temperature of the heating air at this position is still below the maximum permitted surface temperature or below a lower limit temperature which is desired by the vehicle manufacturer.

According to exemplary embodiments, there is provision for the heat exchanger to have a base member and a plurality of ribs which extend substantially parallel with each other in the flow direction and preferably extend integrally outwards from the base member.

Further developments may make provision here for, in an air heater, the separation element to be positioned on abutment faces which are formed by a small part-number of the ribs so that the inner heating air channel portion is substantially subdivided into corresponding rib channels which are each delimited by adjacent ribs, the separation element and the outer wall of the base member of the heat exchanger. Since the separation element is positioned on the abutment faces, however, the ribs no longer extend into the outer heating air channel portion.

Another preferred refinement may make provision for outer edges of the ribs to be recessed in the portion for receiving the separation element in comparison with the configuration thereof in the non-subdivided heating air channel portion. This is intended to be understood to mean that the height of the outer edge which provides a support face or a receiving member for the separation element is smaller over an outer surface of the (massive) base member of the heat exchanger in comparison with the corresponding height in the non-subdivided heating air channel portion. More space thereby remains above (in the direction towards the outer housing) of the ribs and the separation element for the outer heating air channel portion.

A particular further development of the air heater makes provision for the subassembly for generating heat to have an evaporator with a combustion chamber, therefore the air heater is an air heater based on burner/fuel.

This means the subassembly for generating heat is preferably a burner subassembly which comprises an evaporator and a combustion chamber, that is to say is in the form of an evaporating burner. The burner subassembly may preferably further comprise additional elements, such as, for example, a glow plug. In this case, the suction opening, the heat exchanger and the discharge opening can substantially determine a longitudinal direction along a longitudinal axis of the air heater which is parallel with the flow direction. With such a construction, it is particularly advantageous for the separation element to generally form a cap and to surround or cover within the outer housing a rear region, when viewed in the longitudinal direction, of the heat exchanger. Such a cap can also be referred to as a cooling cap with regard to its effect on the external temperature on the outer housing. An advantage involves the maximum temperatures being reached in this construction, particularly in the rear region of the heat exchanger. However, this is not only because here the heating air has already travelled the longest distance past the heat exchanger (with the result that it has then cumulatively taken up the greatest quantity of heat). Instead, it is also because both inside the heat exchanger, as described in the introduction, the impact flow of the combustion gas leads to a maximum heat transfer to a rear wall of the heat exchanger and in the heating air channel the flow is redirected in the rear region in order to guide the heating air at the rear around the heat exchanger in the direction towards the longitudinal centre axis, where the discharge opening is positioned with the axial construction so that also here an impact flow takes place with an increased heat transfer to the outer housing. In other words, the cap surrounds the region of the heat exchanger which would lead to the maximum temperatures at an outer surface of the outer housing during operation without any separation element or cap. As a result of the cap, however, this effect is compensated for and a uniform temperature distribution over the outer surface of the outer housing is obtained.

Another advantage of the configuration of the separation element as a cap is that a number of several individual separation elements is not necessary but instead a unitary component can be provided so that the number of parts is reduced.

Yet another advantage of the cap is achieved in that it can be used as an optional component in batch production. For example, a more cost-effective variant, which is reduced in terms of heating power, of an air heater can be produced and marketed with otherwise unchanged geometry, particularly of the heat exchanger without the cooling cap. Adaptation of the geometry of the heat exchanger for this variant is thereby dispensed with.

A further development of the aspect in which the separation element is in the form of a cap makes provision for an outflow region to be determined in the cap in the region of the discharge opening of the outer housing, in which outflow region the part-flows, which are separated during operation by the separation element into the inner heating air channel portion and the outer heating air channel portion, of the heating air are combined again before the discharge.

According to another exemplary embodiment, the heat exchanger is a counter-flow heat exchanger in which during operation hot combustion gas strikes as an impact flow a wall in a rear region, when viewed in the longitudinal direction, of the heat exchanger, is radially redirected and discharged in the opposite direction, wherein the heat exchanger takes up a maximum temperature during operation in the rear region. The advantages were already set out above.

According to another exemplary embodiment, the separation element has a length in the longitudinal direction so that a quantity of heat, which is taken up in the operation provided for the air heater up to introduction into the outer heating air channel portion in the heating air from the heat exchanger, leads to a temperature which is compatible with the limit values which are accordingly provided in ECE R-122. The advantages resulting from this were also already set out above.

Not only, but particularly in the embodiment of the separation element as a cap, an overheating temperature sensor can advantageously be arranged in the outer and/or inner heating air channel portion. Other temperature-sensitive components can also be received in the outer heating air channel portion, that is to say between the cap and outer housing or housing shell, where they are protected more powerfully.

Other embodiments relate to the separation element: it may be made from a metal material, preferably from the same material as the heat exchanger, more preferably from aluminium. This increases the service-life in view of the temperatures to be anticipated. With the same materials between the cap and the heat exchanger, the thermal expansion coefficients are also adapted to each other and thermally caused mechanical stresses are easier to handle. With regard to the attachment, the cap is connected by means of a clip-fit connection to the heat exchanger. To this end, for example, openings in which cams which are configured on the heat exchanger engage can be provided in the cap. Furthermore, the heat exchanger may have a small number of abutment locations, against which the cap can bear. The surface contact between the cap and the heat exchanger is selected to be as small as possible here in order to reduce the thermal conduction. During production/assembly, the cap can simply be fitted on the heat exchanger at the front.

In such an exemplary embodiment, the separation element can be a component which is produced in a deep-drawing or press method, preferably as sheet aluminium. This allows a cost-effective production.

Alternatively, however, the separation element can also be produced from a high-performance plastics material.

Another embodiment makes provision for the separation element to be retained with spacing by one or more insulation pads with respect to the outer housing. A heat transmission to the outer housing is thereby reduced when the outer housing is mechanically retained or supported via the cap. In addition to introduction on the separation element, a positioning of the insulation pad in the housing shell or on the housing is also conceivable.

It should be noted that according to aspects of the invention as a result of the reduction of the convective heat transmission from the heat exchanger to the outer housing by using the cooling cap the permitted surface temperatures can still be complied with particularly also in malfunctions which are undesirable in and of themselves, such as, for example, during overheating as a result of blockage of the suction opening, with a corresponding configuration.

In the aspects of the invention as proposed here, the separation of the flow of the heating air into part-flows, on the one hand, can bring about a reduction of the convective heat transmission in the region of high heating air temperatures to the outer housing or the housing shell and, on the other hand, a reduction of the heating air temperature itself near the wall. The surface temperatures of the outer housing or of one or more of the respective housing shells can thus be reduced effectively in the event of an additional pressure decrease, even only a small one.

### BRIEF DESCRIPTION OF THE DRAWINGS

The invention is explained by way of example below with reference to the following Figures. In the drawings:

FIG. 1 shows a schematic longitudinally sectioned view of an overview of a conventional air heater which is operated with fuel or combustible;

FIG. 2 shows a longitudinally sectioned view of an overview of an air heater which is operated with fuel or combustible according to one exemplary embodiment;

FIG. 3 shows a perspective view of the air heater from FIG. 2 with the rear housing shell being removed;

FIGS. 4A, B show the separation element, in the form of a cap, of the air heater from FIG. 3 in two different variants (with and without insulation pads); shows the heat exchanger of the air heater from FIG. 3 with a fitted cap FIG. 5 as a perspective view;

FIG. 6 is similar to FIG. 5, but shown as a side view.

### DETAILED DESCRIPTION

In the following description of the drawings, the same reference numerals denote the same or comparable components. The features of the invention which are disclosed in the present description, in the drawings and in the claims may be significant for carrying out the invention both individually and in any combination.

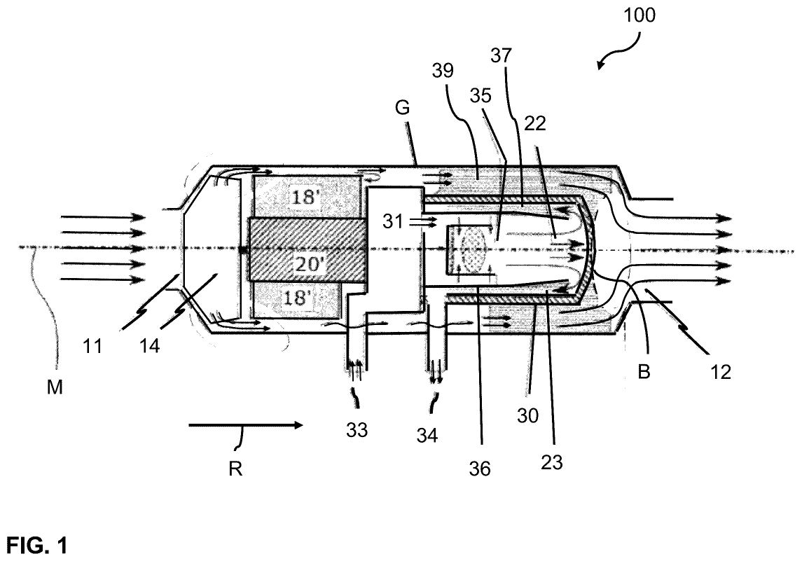

FIG. 1 shows a schematic longitudinally sectioned view of an overview of a conventional air heater 100 which is operated with fuel or combustible. The air heater 100 is intended, for example, for use in a motor vehicle. The air heater 100 has an outer housing G having a suction opening 11 for heating air and having a discharge opening 12 for the heated heating air. In a heat exchanger 30 of the air heater 100 there is a combustion chamber housing 36 having a combustion chamber 35 operated with combustible. A combustion air blower31 which is in the form of a lateral channel blower (not shown in detail) ensures the air supply (oxidant) and air throughflow of the combustion chamber 35. The combustion air face 31 is connected to a laterally arranged air inlet 33, from which it draws in the combustion air. There are similarly not shown in detail a combustible supply line, an evaporator for the combustible and an ignition member for starting a combustion operation. The combustible and the combustion air which contains the oxidant are brought into a chemical reaction in the combustion chamber 35 in order to generate heat.

The heating air is drawn in from the environment via the suction opening 11 by means of a heating air blower 14 at a front side of the air heater 100 and is discharged through the discharge opening 12 in a heated state at a rear side, opposite the front side, of the air heater after flowing around the heat exchanger 30 in corresponding heating air channels 39. The suction opening 11 and the discharge opening 12 of the air heater 100 are located, purely by way of example, on a common spatial longitudinal axis M of the heat exchanger 30 and the combustion chamber 35, along which the air flows through the air heater 100. The combustion air blower 31 and the heating air blower 14 are together driven by a drive motor 20′ which is controlled in known manner by a control apparatus 18′, in particular in accordance with a required heating power.

At an exhaust gas side of the heat exchanger 30, hot combustion gas flows after combustion in the combustion chamber 35 as an impact flow 22 along the longitudinal axis M against a wall in a rear region B, in the longitudinal direction R, of the heat exchanger. FIG. 1 shows the combustion chamber 35 purely schematically and a flame tube which tapers in the flow direction can generally adjoin it. After leaving the combustion chamber or the flame tube and the impact flow against the wall of the heat exchanger, the combustion gas is redirected sharply through 180° and then flows in the flow direction 23, which is counter to the heating air flow externally at the heat exchanger 30, to the exhaust gas outlet 34 through the heat exchanger 30. A heat exchanger configured in this manner can also be referred to as a counter-flow heat exchanger. As a result of the high flow speeds and the sharp redirection of the flow, an impact flow 22 with a very high heat transmission to this wall is produced at the wall in the rear region B of the heat exchanger 30 at the exhaust gas side.

The exhaust gas is directed away by flow channels 37 which are formed, for better heat transmission, by ribs which project inwardly from an inner surface of the heat exchanger 30 and which extend along the longitudinal axis M (not shown). As a result of this construction, during operation in the rear region B the heat exchanger 30 takes up a maximum temperature which decreases with continuing heat transmission along the flow channels 37 from the rear towards the front. Accordingly, the heating air in the heating air channels 39 near the rear region B reaches the highest temperatures before it is discharged from the discharge opening 12. It discharges its heat to the outer housing G. As a result of the conventionally, comparatively low power densities, however, the air heater 100 can reach surface temperatures at the outer housing G which are still in the permitted range defined by legislators in the Regulation ECE R-122.

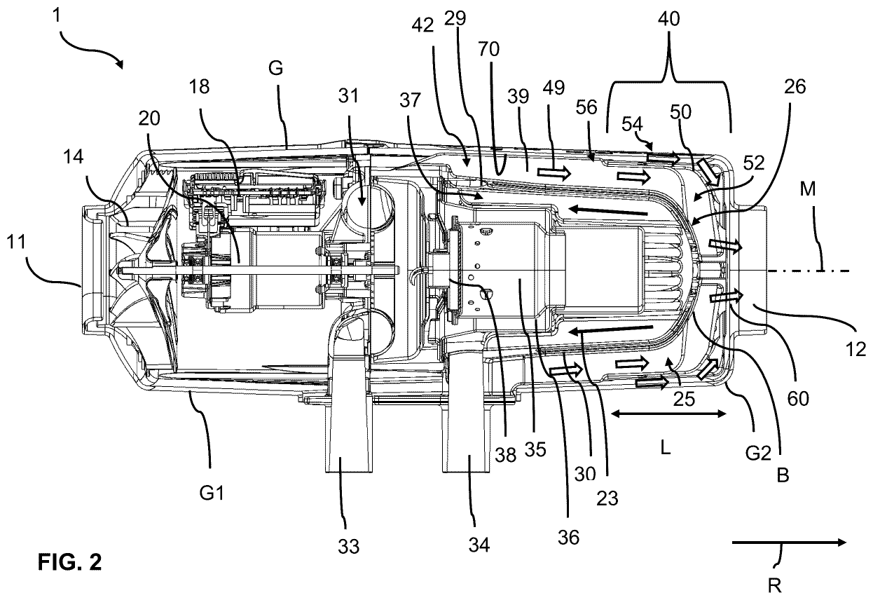

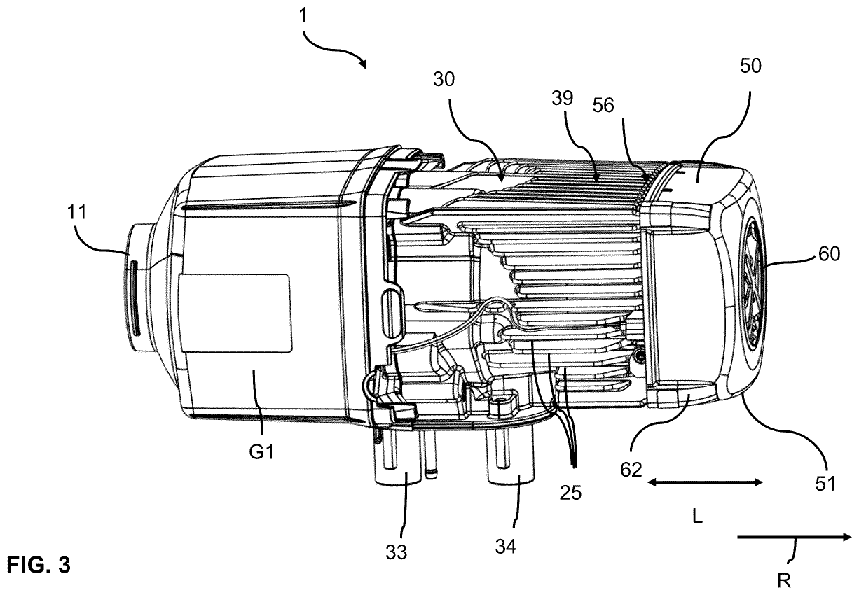

FIG. 2 shows a fuel-operated air heater 1 according to an exemplary embodiment which is constructed in a substantially more compact manner than the one in FIG. 1 and therefore has an increased power density. A number of differences from the example of FIG. 1 are explained below while reference may be made to the above description with regard to corresponding features. The air heater 1 has an outer housing G which is formed from two housing shells. In FIG. 3, the front housing shell G1 is shown in this regard while the rear housing shell G2 is removed so that a corresponding heat exchanger 30 can be seen. The front housing shell G1 has a suction opening 11 and the rear housing shell G2 has a discharge opening 12, between which the heating air channel(s) 39 extend. A heating air blower 14 which is driven by a drive motor 20′ ensures the throughflow of the heating air channel(s) 39 with heating air. The drive motor 20′ is controlled by a control apparatus 18′ in known manner similarly to what is described above.

The outer housing G receives the mentioned components similarly to the heat exchanger 30, as shown in FIG. 2. The heat exchanger 30 comprises a substantially cylindrical base member 26 with a closure wall in a rear region B thereof. There extend radially outwardly from a similarly substantially cylindrical outer wall 29 of the base member 26 ribs 25 with mutually identical spacing in the circumferential direction. The heat exchanger 30 generally has axial symmetry, whereby a longitudinal axis M which further extends in the exemplary embodiment through the suction opening 11 and the discharge opening 12 is determined. A direction R parallel with the longitudinal axis M, which substantially correspond to the flow direction 49 in the heating air channel(s), is determined from the suction opening 11 to the discharge opening 12.

The heat exchanger 30 has an inner space which opens counter to the direction R and which receives a combustion chamber housing 36 with a combustion chamber 35 which is operated with combustible. A combustion air blower 31 which is in the form of a lateral channel blower and which is driven by the same drive motor 20′ ensures the air supply (oxidant) and air throughflow of the combustion chamber 35. The combustion air blower 31 is connected to a laterally arranged air inlet 33, from which it draws in the combustion air during operation. There are similarly not shown in detail a combustible supply line, an evaporator 38 for the combustible and an ignition member for starting a combustion operation. The combustible and the combustion air which contains the oxidant are brought into a chemical reaction in the combustion chamber 35 in order to generate heat.

After leaving the combustion chamber or a flame tube, which is not shown in detail, and the impact flow against the rear wall of the heat exchanger 30, the combustion gas is redirected sharply through 180° and then flows in the flow direction 23, which is counter to the flow direction 49 of the heating air externally at the heat exchanger 30 in flow channels 37 which are formed by inner ribs (not shown in detail) to the exhaust gas outlet 34 through the heat exchanger 30 and is discharged there.

As can clearly be seen in FIG. 2, the heating air flows in the heating air channel 39 in the flow direction 49 in a portion 42, the inner space of which is determined when viewed in the radial direction away from the longitudinal axis M between the outer wall 29 of the base member 26 of the heat exchanger 30 and an inner wall 70 of the outer housing G (or the front housing shell G2) but which extends in a circumferential direction around the heat exchanger 30.

As can better be seen in the perspective view of FIG. 3, in which the rear housing shell G2 is removed, a separation element 50 which is in the form of a cap 51 is placed on a rear end of the heat exchanger. The separation element 50 extends in the circumferential direction around the heat exchanger 30 and follows the outer contour which is formed by the ribs 25 thereof. Furthermore, the cap 51 also covers, as a result of its shape, a portion of the rear region B of the heat exchanger 30. The cap 51 has a length L along the longitudinal axis M. Over this length L, consequently, there is formed between the separation element 50 (more specifically: an inner surface of the separation element 50) and the outer wall 29 of the base member 26 of the heat exchanger 30 an inner heating air channel portion 52. This inner heating air channel portion 52 is further subdivided by the ribs 25. However, the cap 51 or the separation element 50 is not located on each rib 25, but instead preferably touches the heat exchanger simply at a small number of abutment faces or locations in order to limit a heat transmission to the separation element 50 by thermal conduction. Consequently, the rib channels formed by the subdivision are connected to each other and together form the inner heating air channel portion 52. The separation element 50 is made from aluminium in the exemplary embodiment, similarly to the heat exchanger 30.

As FIG. 2 shows, the separation element 50 is received inside the outer housing G or the front housing shell G2, but with spacing therefrom in order to form an outer heating air channel portion 54 between an outer surface of the cap 51 or the separation element 50 and the inner wall 70 of the outer housing G. This outer heating air channel portion 54 is not subdivided by ribs. The inner heating air channel portion 52 and the outer heating air channel portion 54 are separated from each other by the separation element 50. Both portions have the length L when measured along the longitudinal axis M (disregarding a redirection which can be seen in FIG. 2 towards the longitudinal axis M at the rear end of the heat exchanger).

A region, which extends beyond the length L, of the heat exchanger 30 is formed by the above-described portion 42 which is not subdivided in the radial direction. Consequently, there is located between the one-piece portion 42, on the one hand, and the inner and outer heating air channel portions 52, 54, on the other hand, an inflow region 56 which is formed by an inlet edge of the separation element 50. The heating air flow is divided at this location into accordingly two parallel part-flows: an outer heating air flow and an inner heating air flow.

Over the length L, the inner heating air flow takes up substantially more heat from the base member 26 and the ribs 25 than the outer heating air flow does from the separation element, for which reason the outer heating air flow takes up a slightly lower temperature than the inner heating air flow. Accordingly, during operation the temperature of the outer housing G is also substantially lower, in particular at the rear end of the air heater 1, in comparison with a case in which the separation element 50 is not provided with an otherwise identical construction. An overheating sensor or a temperature sensor (both not shown in the Figures) can be arranged in the inner heating air channel portion 52 or the outer heating air channel portion 54 (or each in both).

The separation element 50 has, in order to form the cap shape 4, lateral faces 50a, 50b, 50c and 50d which are substantially perpendicular to each other and an end face 50e, in which a circular opening which forms a central outflow region 60 in the fitted state is formed. This opening corresponds with regard to its position to the discharge opening 12 of the outer housing. The end face 50e follows the outer contour of the rear region B of the heat exchanger 30, consequently continues the inner and outer heating air channels 52, 54 which are formed by the lateral faces 50a, 50b, 50c, 50d as far as the outflow region 60. In this portion, the heating air flow is redirected inwardly towards the discharge opening 12.

The cap 51 which is shown in FIG. 3 or the separation element 50 can be provided with insulation pads 62 at the outer edges of the parallelepipedal profile. They can come into mechanical contact with the outer housing G or the front housing shell G2. The insulation pads 62 are made from a heat-resistant material which has a low thermal conductivity. The insulation pads 62 act as contact locations merely for the exceptional case. Within nominal dimensions and within the tolerances, the heat exchanger 30 or the separation element 50 does not touch the housing shells G1, G2 without substantial application of force to the housing shells from the exterior. In order to take up where applicable excessively high force effects by the application, however, the insulation pads 62 are positioned so that the heat exchanger 30 in any position always comes into contact initially with only one of the insulation pads 62 instead of touching the corresponding housing shell G1, G2 and thereby introducing greatly excessively high temperatures into the housing shells G1, G2.

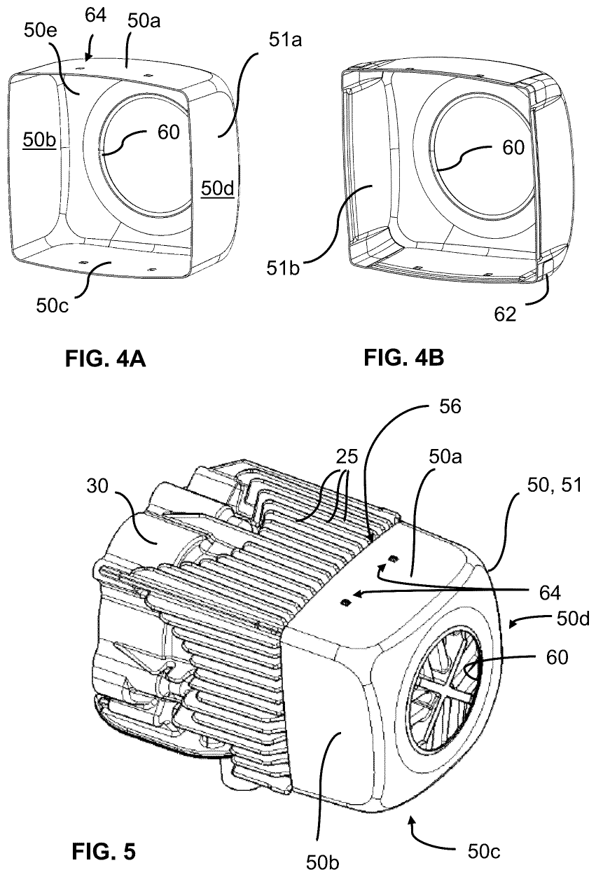

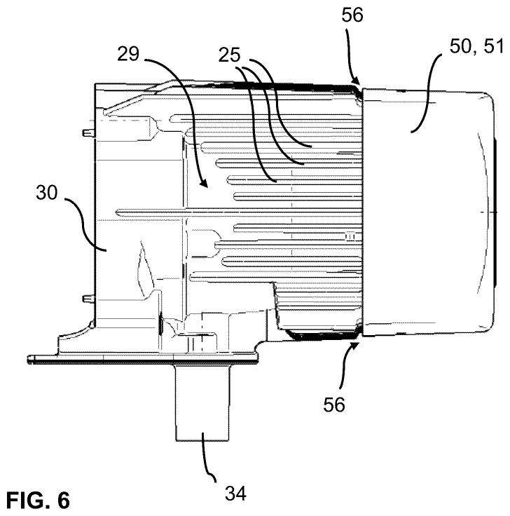

FIG. 4B shows the corresponding cap 51 (here with the reference numeral 51b for differentiation) in a state before assembly on the heat exchanger 30. A preferred embodiment shown in FIG. 4A makes provision for not configuring any insulation pads on the cap 51 (designated 51a in FIG. 4A). This alternative embodiment of an air heater 1 is shown as the perspective partial view of FIG. 5 and the side view of FIG. 6, wherein, however, there only the heat exchanger 30 is shown with the positioned cap 51 without any outer housing G and additional components. The two alternative separation elements 51a, 51b can be exchanged, for example in FIG. 2, without adaptations to other components having to be carried out. Both the heat exchanger 30 with the separation element 50 and the outer housing G or the front housing shell G2 can be secured directly or indirectly to a carrier component or frame element, which is not shown in detail in the Figures, of the air heater 1 and therefore do not necessarily need to touch each other, as described. In this regard, by omitting dedicated contact locations a heat transmission from the separation element 50 to the outer housing G in this embodiment is also substantially reduced again.

The separation element 50 or the cap 51 can be attached, as can be roughly seen with reference to FIG. 5, by means of two cams on the heat exchanger 30 (top and bottom) which engage in corresponding openings 64 at opposite lateral faces 50a, 50c on the cap 51. At the same time, on the left and right sides of the heat exchanger 30 three abutment locations at which the cap 51 can be positioned by means of its opposite lateral faces 50b, 50d are formed. This serves to keep the surface contact between the heat exchanger 30 and the cap 51 as small as possible in order to reduce as far as possible the thermal conduction into the cap 51 or the separation element 50.

It may be noted that other modifications, particularly with regard to the separation element 50, are also possible. For example, the separation element is formed in one piece in the embodiments. According to modifications, however, it can also be configured with several pieces. For example, the lateral faces 50a, b, c, d shown in FIG. 4A can also be provided as an individual element. Furthermore, the separation element 50 can also be provided without any cap shape by having only the lateral faces 50a, b, c, d but not the end face 50e which is shown in FIG. 4A.

### LIST OF REFERENCE NUMERALS

1 Air heater
11 Suction opening (heating air)
12 Discharge opening (heating air)
14 Heating air blower
18′ Control apparatus
20′ Drive motor
22 Impact flow
23 Flow direction (combustion gas redirected through 180° C.)
25 Ribs (externally on heat exchanger)
26 Base member (heat exchanger)
29 Outer wall (base member of heat exchanger)
30 Heat exchanger
31 Combustion air blower
33 Air inlet (combustion air)
34 Exhaust gas outlet
35 Combustion chamber
36 Combustion chamber housing
37 Flow channels (combustion gas)
38 Evaporator
39 Heating air channel
40 Portion
42 Non-subdivided heating air channel portion
49 Flow direction
50 Separation element
51 Cap
52 Inner heating air channel portion
54 Outer heating air channel portion
56 Inflow region
60 Outflow region
62 Insulation pads
70 Inner wall (outer housing)
100 Air heater (conventional)
B Rear region of heat exchanger
G Outer housing
M Longitudinal axis
R Longitudinal direction

1. An air heater for a vehicle comprising:
a subassembly for generating heat;
a heat exchanger which thermally interacts with the subassembly;
an outer housing which receives the subassembly and the heat exchanger, wherein the outer housing and the heat exchanger together form at least one heating air channel which is formed by an inner wall of the housing and an outer wall of the heat exchanger;
a heating air blower which is configured to draw in heating air via a suction opening of the outer housing and to convey it in a flow direction through the at least one heating air channel and to discharge the heating air via a discharge opening of the outer housing; and
a separation element which is arranged in the at least one heating air channel and which extends in a portion of the heating air channel in the flow direction determined by the operation of the heating air blower;
wherein the separation element subdivides in this portion the heating air channel into an inner heating air channel portion which is determined between the separation element and the outer wall of the heat exchanger and an outer heating air channel portion which is determined between the separation element and the inner wall of the housing, so that the heating air which flows in the heating air channel during operation is divided at an inflow region into the two heating air channel portions into correspondingly two parallel part-flows.

2. The air heater according to claim 1, wherein both the inner heating air channel portion and the outer heating air channel portion are together connected to a non-subdivided heating air channel portion which extends continuously from the inner wall of the outer housing as far as the outer wall of the heat exchanger at the side thereof which determines the inflow region for heating air counter to the flow direction of the heating air.

3. The air heater according to claim 1, wherein the heat exchanger has a base member and a plurality of ribs which extend, in particular substantially parallel with each other, in the flow direction and outwards from the base member.

4. The air heater according to claim 3, wherein the separation element is positioned on abutment locations which are formed by at least a part-number of the ribs so that the inner heating air channel portion is substantially subdivided into corresponding rib channels which are each delimited by adjacent ribs, the separation element and the outer wall of the base member of the heat exchanger.

5. The air heater according to claim 4, wherein outer edges of the ribs are recessed in the portion for receiving the separation element in comparison with the configuration thereof in the non-subdivided heating air channel portion.

6. The air heater according to claim 5, wherein the subassembly for generating heat has an evaporator with a combustion chamber;
the suction opening, the heat exchanger and the discharge opening substantially determine a longitudinal direction along a longitudinal axis of the air heater which is parallel with the flow direction;
the separation element forms a cap and surrounds within the outer housing a rear region, when viewed in the longitudinal direction, of the heat exchanger.

7. The air heater according to claim 6, wherein an outflow region is determined in the cap in the region of the discharge opening of the outer housing, in which the part-flows, which are separated during operation by the separation element into the inner heating air channel portion and the outer heating air channel portion, of the heating air are combined again before the discharge.

8. The air heater according to claim 6, wherein the heat exchanger is a counter-flow heat exchanger in which during operation hot combustion gas strikes as an impact flow a wall in a rear region, when viewed in the longitudinal direction, of the heat exchanger, is radially redirected and discharged in the opposite direction, wherein the heat exchanger takes up a maximum temperature in the rear region.

9. The air heater according to claim 6, wherein an overheating temperature sensor is arranged in at least one of: the outer heating air channel portion and the inner heating air channel portion.

10. The air heater according to claim 6, wherein the separation element is made from a metal material.

11. The air heater according to claim 6, wherein the separation element is a component produced in a deep-drawing or press method.

12. The air heater according to claim 6, wherein the separation element is produced from a high-performance plastics material.

13. The air heater according to claim 6, wherein the separation element is retained with spacing by one or more insulation pads with respect to the outer housing.
